(19) United States
(12) Patent Application Publication
(10) Pub. No.: US 2017/0041355 A1
(43) Pub. Date: Feb. 9, 2017

(54) CONTEXTUAL INFORMATION FOR AUDIO-ONLY STREAMS IN ADAPTIVE BITRATE STREAMING

(71) Applicant: ARRIS Enterprises LLC, Suwanee, GA (US)

(72) Inventors: Shailesh Ramamurthy, Bengaluru (IN); Senthilprabu Vadhugepalayam Shamugan, Bengaluru (IN); Karthick Somalinga Nagarajamoorthy, Bangalore (IN); Manu Shrot, Bangalore (IN)

(21) Appl. No.: 15/225,960

(22) Filed: Aug. 2, 2016

Related U.S. Application Data
(60) Provisional application No. 62/200,307, filed on Aug. 3, 2015.

(51) Int. Cl. H04L 29/06

(52) U.S. Cl. CPC H04L 65/1089; H04L 65/4069; H04L 43/0882

(57) ABSTRACT

A method is provided to presenting contextual information during adaptive bitrate streaming to allow play of an audio-only variant. The method includes receiving an audio-only variant of a video stream, calculating bandwidth headroom, receiving contextual information that provides descriptive information about visual components of the video stream that has a bitrate less than the bandwidth headroom, and presenting the contextual information to users while playing the audio-only variant.

### CLAIM OF PRIORITY

This application claims priority under 35 U.S.C. §119(e) from earlier filed U.S. Provisional Application Ser. No. 62/200,307, filed Aug. 3, 2015, which is hereby incorporated by reference.

### TECHNICAL FIELD

The present disclosure relates to the field of digital video streaming, particularly a method of presenting contextual information during audio-only variants of a video stream.

### BACKGROUND

Streaming live or prerecorded video to client devices such as set-top boxes, computers, smartphones, mobile devices, tablet computers, gaming consoles, and other devices over networks such as the internet has become increasingly popular. Delivery of such video commonly relies on adaptive bitrate streaming technologies such as HTTP Live Streaming (HLS), HTTP Dynamic Streaming (HDS), Smooth Streaming, and MPEG-DASH.

Adaptive bitrate streaming allows client devices to transition between different variants of a video stream depending on factors such as network conditions and the receiving client device's processing capacity. For example, a video can be encoded at a high quality level using a high bitrate, at a medium quality level using a medium bitrate, and at a low quality level using a low bitrate. Each alternative variant of the video stream can be listed on a playlist such that the client devices can select the most appropriate variant. A client device that initially requested the high quality variant when it had sufficient available bandwidth for that variant can later request a lower quality variant when the client device's available bandwidth decreases.

Content providers often make an audio-only stream variant available to client devices, in addition to multiple video stream variants. The audio-only stream variant is normally a video's main audio components, such that a user can hear dialogue, sound effects, and/or music from the video even if they cannot see the video's visual component. As visual information generally needs more bits to encode than audio information, the audio-only stream can be made available at a bandwidth lower than the lowest quality video variant. For example, if alternative video streams are available at a high bitrate, a medium bitrate, and a low bitrate, an audio-only stream can be made available so that client devices without sufficient bandwidth for even the low bitrate video stream variant can at least hear the video's audio track.

While an audio-only stream can be useful in situations in which the client device has a slow network connection in general, it can also be useful in situations in which the client device's available bandwidth is variable and can drop for a period of time to a level where an audio-only stream is a better option than attempting to stream a variant of the video stream.

For example, a mobile device can transfer from a high speed WiFi connection to a lower speed cellular data connection when it moves away from the WiFi router. Even if the mobile device eventually finds a relatively high speed cellular data connection there can often be a quick drop in available bandwidth during the transition, and an audio-only stream can be used during that transition period.

Similarly, the bandwidth available to a mobile device over a cellular data connection can also be highly variable as the mobile device physically moves. Although a mobile device may enjoy a relatively high bandwidth 4G connection in many areas, in other areas the mobile device's connection can be dropped to a lower bandwidth connection, such as a 3G or lower connection. In these situations, when the mobile device moves to an area with a slow cellular data connection, it may still be able to receive an audio-only stream.

However, while an audio-only stream can in many situations be a better option than stopping the stream entirely, the visual component of a video is often important in providing details and context to the user. Users who can only hear a video's audio components may lack information they would otherwise gain through the visual component, making it harder for the user to understand what is happening in the video. For example, a user who can only hear a movie's soundtrack may miss visual cues as to what a character is doing in a scene and miss important parts of the plot that aren't communicated through audible dialogue alone.

What is needed is a method of using bandwidth headroom beyond what a client device uses to receive an audio-only stream to provide contextual information about the video's visual content, even if the client device does not have enough bandwidth to stream the lowest quality video variant.

### SUMMARY

In one embodiment the present disclosure provides for a method of presenting contextual information during adaptive bitrate streaming, the method comprising receiving with a client device an audio-only variant of a video stream from a media server, wherein the audio-only variant comprises audio components of the video stream, calculating bandwidth headroom by subtracting a bitrate associated with the audio-only variant from an amount of bandwidth currently available to the client device, receiving with the client device one or more pieces of contextual information from the media server, wherein the one or more pieces of contextual information provide descriptive information about visual components of the video stream, and wherein the bitrate of the one or more pieces of contextual information is less than the calculated bandwidth headroom, playing the audio components for users with the client device based on the audio-only variant, and presenting the one or more pieces of contextual information to users with the client device while playing the audio components based on the audio-only variant.

In another embodiment the present disclosure provides for a method of presenting contextual information during adaptive bitrate streaming, the method comprising receiving with a client device one of a plurality of variants of a video stream from a media server, wherein the plurality of variants comprises a plurality of video variants that comprise audio components and visual components of a video, and an audio-only variant that comprises the audio components, wherein each of the plurality of video variants is encoded at a different bitrate and the audio-only variant is encoded at a bitrate lower than the bitrate of the lowest quality video variant, selecting to receive the audio-only variant with the client device when bandwidth available to the client device is lower than the bitrate of the lowest quality video variant, calculating bandwidth headroom by subtracting the bitrate of the audio-only variant from the bandwidth available to the client device, downloading one or more types of contextual information to the client device from the media server with the bandwidth headroom, the one or more types of contextual information providing descriptive information about the visual components, and playing the audio components for users with the client device based on the audio-only variant and presenting the one or more types of contextual information to users with the client device while playing the audio components based on the audio-only variant, until the bandwidth available to the client device increases above the bitrate of the lowest quality video variant and the client device selects to receive the lowest quality video variant.

In another embodiment the present disclosure provides for a method of presenting contextual information during adaptive bitrate streaming, the method comprising receiving with a client device one of a plurality of variants of a video stream from a media server, wherein the plurality of variants comprises a plurality of video variants that comprise audio components and visual components of a video, and a pre-mixed descriptive audio variant that comprises the audio components mixed with a descriptive audio track that provides descriptive information about the visual components, wherein each of the plurality of video variants is encoded at a different bitrate and the pre-mixed descriptive audio variant is encoded at a bitrate lower than the bitrate of the lowest quality video variant, selecting to receive the pre-mixed descriptive audio variant with the client device when bandwidth available to the client device is lower than the bitrate of the lowest quality video variant, and playing the pre-mixed descriptive audio variant for users with the client device, until the bandwidth available to the client device increases above the bitrate of the lowest quality video variant and the client device selects to receive the lowest quality video variant.

### BRIEF DESCRIPTION OF THE DRAWINGS

Further details of the present invention are explained with the help of the attached drawings in which:

FIG. 1 depicts a client device receiving a variant of a video via adaptive bitrate streaming from a media server.

FIG. 2 depicts an example of a client device transitioning between chunks of different variants.

FIG. 3 depicts an exemplary master playlist.

FIG. 4 depicts an example in which the lowest quality video variant is available at 256 kbps and an audio-only variant is available at a lower bitrate of 64 kbps.

FIG. 5 depicts an embodiment in which contextual information is a text description of a video's visual component.

FIG. 6 depicts an exemplary process for automatically generating text contextual information from a descriptive audio track using a speech recognition engine.

FIG. 7 depicts an embodiment in which contextual information is an audio recording that describes a video's visual component.

FIG. 8 depicts an embodiment in which contextual information is a pre-mixed audio recording that combines a video's original audio components with an audible description of the video's visual component.

FIG. 9 depicts the syntax of an AC-3 descriptor through which a descriptive audio track in a video's audio components can be identified.

FIG. 10 depicts an embodiment in which contextual information is one or more images that show a portion of a video's visual component.

FIG. 11 depicts an example of a master playlist that indicates a location for an I-frame playlist for each video variant.

FIG. 12 depicts an exemplary embodiment of a method of selecting a type of contextual information depending on the headroom currently available to a client device.

### DETAILED DESCRIPTION

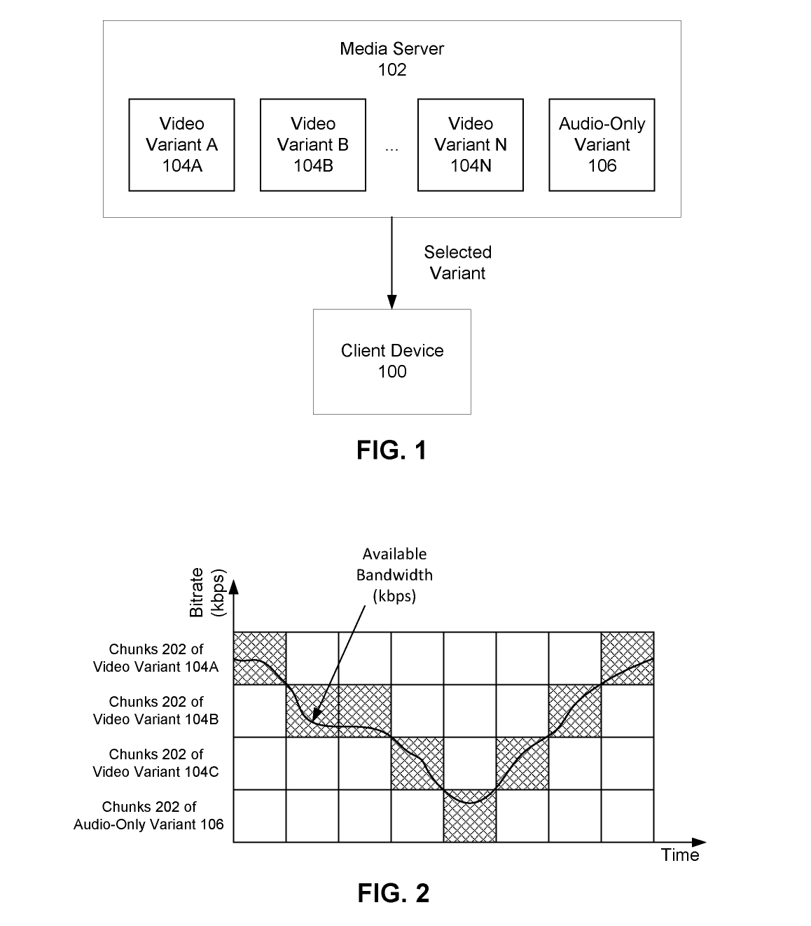

FIG. 1 depicts a client device 100 in communication with a media server 102 over a network such that the client device 100 can receive video from the media server 102 via adaptive bitrate streaming. The video can have a visual component and one or more audio components. By way of non-limiting examples, the video can be a movie, television show, video clip, or any other video.

The client device 100 can be a set-top box, cable box, computer, smartphone, mobile device, tablet computer, gaming console, or any other device configured to request, receive, and play back video via adaptive bitrate streaming. The client device 100 can have one or more processors, data storage systems or memory, and/or communication links or interfaces.

The media server 102 can be a server or other network element that stores, processes, and/or delivers video to client devices 100 via adaptive bitrate adaptive streaming over a network such as the internet or any other data network. By way of non-limiting examples, the media server 102 can be an Internet Protocol television (IPTV) server, over-the-top (OTT) server, or any other type of server or network element. The media server 102 can have one or more processors, data storage systems or memory, and/or communication links or interfaces.

The media server 102 can deliver video to one or more client devices 100 via adaptive bitrate streaming, such as HTTP Live Streaming (HLS), HTTP Dynamic Streaming (HDS), Smooth Streaming, MPEG-DASH streaming, or any other type of adaptive bitrate streaming. In some embodiments, HTTP (Hypertext Transfer Protocol) can be used as a content delivery mechanism to transport video streams from the media server 102 to a client device 100. In other embodiments, other transport mechanisms or protocols such as RTP (Real-time Transport Protocol) or RTSP (Real Time Streaming Protocol) can be used to deliver video streams from the media server 102 to client devices 100. The client device 100 can have software, firmware, and/or hardware through which it can request, decode, and play back streams from the media server 102 using adaptive bitrate streaming. By way of a non-limiting example, a client device 100 can have an HLS player application through which it can play HLS adaptive bitrate streams for users.

For each video available at the media server 102, the media server 102 can store a plurality of video variants 104 and at least one audio-only variant 106 associated with the video. In some embodiments, the media server 102 can comprise one or more encoders that can encode received video into one or more video variants 104 and/or audio-only variants 106. In other embodiments, the media server 102 can store video variants 104 and audio-only variants 106 encoded by other devices.

Each video variant 104 can be an encoded version of the video's visual and audio components. The visual component can be encoded with a video coding format and/or compression scheme such as MPEG-4 AVC (H.264), MPEG-2, HEVC, or any other format. The audio components can be encoded with an audio coding format and/or compression scheme such as AC-3, AAC, MP3, or any other format. By way of a non-limiting example, a video variant 104 can be made available to client devices 100 as an MPEG transport stream via one or more .ts files that encapsulates the visual components encoded with MPEG-4 AVC and audio components encoded with AAC.

Each of the plurality of video variants 104 associated with the same video can be encoded at a different bitrate. By way of a non-limiting example, a video can be encoded into multiple alternate video variants 104 at differing bitrates, such as a high quality variant at 1 Mbps, a medium quality variant at 512 kbps, and a low quality variant at 256 kbps.

As such, when a client device 100 plays back the video, it can request a video variant 104 appropriate for the bandwidth currently available to the client device 100. By way of a non-limiting example, when video variants 104 include versions of the video encoded at 1 Mbps, 512 kbps, and 256 kbps, a client device 100 can request the highest quality video variant 104 if its currently available bandwidth exceeds 1 Mbps. If the client device's currently available bandwidth is below 1 Mbps, it can instead request the 512 kbps or 256 kbps video variant 104 if it has sufficient bandwidth for one of those variants.

An audio-only variant 106 can be an encoded version of the video's main audio components. The audio components can be encoded with an audio coding format and/or compression scheme such as AC-3, AAC, MP3, or any other format. While in some embodiments the video's audio component can be a single channel of audio information, in other embodiments the audio-only variant 106 can have multiple channels, such as multiple channels for stereo sound or surround sound. In some embodiments the audio-only variant 106 can omit alternate audio channels from the video's audio components, such as alternate channels for alternate languages, commentary, or other information.

As the audio-only variant 106 omits the video's visual component, it can generally be encoded at a lower bitrate than the video variants 104 that include both the visual and audio components. By way of a non-limiting example, when video variants 104 are available at 1 Mbps, 512 kbps, and 256 kbps, an audio-only variant 106 can be available at a lower bitrate such as 64 kbps. In this example, if a client device's available bandwidth is 150 kbps it may not have sufficient bandwidth to stream the lowest quality video variant 104 at 256 kbps, but would have more than enough bandwidth to stream the audio-only variant 106 at 64 kbps.

FIG. 2 depicts a non-limiting example of a client device 100 transitioning between chunks 202 of different variants. In some embodiments, the video variants 104 and/or audio-only variants 106 can be divided into chunks 202. Each chunk 202 can be a segment of the video, such as a 1 to 30 second segment. The boundaries between chunks 202 can be synchronized in each variant, and the chunks 202 can be encoded such that they are independently decodable by client devices 100. This encoding scheme can allow client devices 100 to transition between different video variants 104 and/or audio-only variants 106 at the boundaries between chunks 202. By way of a non-limiting example, when a client device 100 that is streaming a video using a video variant 104 at one quality level experiences network congestion, it can request the next chunk 202 of the video from a lower quality video variant 104 or drop to an audio-only variant 106 until conditions improve and it can transition back to a video variant 104.

In some embodiments each chunk 202 of a video variant 104 can be encoded such that it begins with an independently decodable key frame such as an IDR (Instantaneous Decoder Refresh) frame, followed by a sequence of I-frames, P-frames, and/or B-frames. I-frames can be encoded and/or decoded through intra-prediction using data within the same frame. A chunk's IDR frame can be an I-frame that marks the beginning of the chunk. P-frames and B-frames can be encoded and/or decoded through inter-prediction using data within other frames in the chunk 202, such as previous frames for P-frames and both previous and subsequent frames for B-frames.

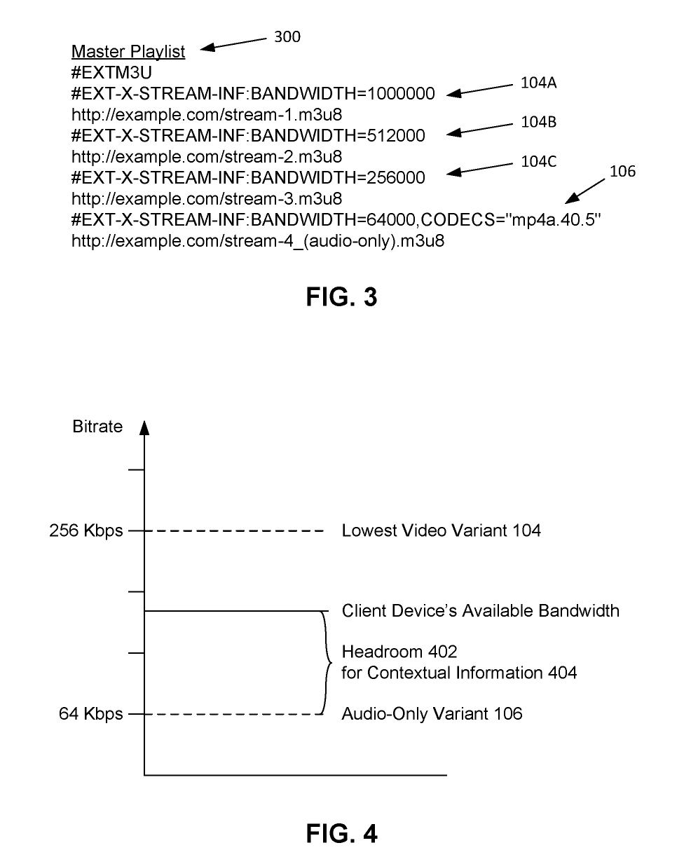

FIG. 3 depicts an exemplary master playlist 300. A media server 102 can publish or otherwise make a master playlist 300 available to client devices 100. The master playlist 300 can be a manifest that includes information about a video, including information about each video variant 104 and/or audio-only variant 106 encoded for the video. In some embodiments, a master playlist 300 can list a URL or other identifier that indicates the locations of dedicated playlists for each individual video variant 104 and audio-only variant 106. A dedicated playlist for a variant can list identifiers for individual chunks 202 of the variant. By way of a non-limiting example, the master playlist 300 shown in FIG. 3 includes URLs for: a “stream-1.m3u8” playlist for a video variant 104 encoded at 1 Mbps; a “stream-2.m3u8” playlist for a video variant 104 encoded at 512 kbps; a “stream-3.m3u8” playlist for a video variant 104 encoded at 256 kbps; and a “stream-4_(audio-only).m3u8” playlist for an audio-only variant 106 encoded at 64 kbps. As shown in FIG. 3, a master playlist 300 can also indicate codecs used for any or all of the variants.

A client device 100 can use a master playlist 300 to consult a dedicated playlist for a desired variant, and thus request chunks 202 of the video variant 104 or audio-only variant 106 appropriate for its currently available bandwidth. It can also use the master playlist 300 to switch between the video variants 104 and audio-only variants 106 as its available bandwidth changes.

FIG. 4 depicts a non-limiting example in which the lowest quality video variant 104 is available at 256 kbps and an audio-only variant 106 is available at a lower bitrate of 64 kbps. The difference between the bitrate of the audio-only variant 106 and a client device's available bandwidth can be considered to be its headroom 402. As shown in the example of FIG. 4, when the lowest quality video variant 104 is encoded at 256 kbps and the audio only variant is encoded at 64 kbps, a client device 100 with an available bandwidth of 150 kbps would not have sufficient bandwidth to stream the 256 kbps video variant 104, but would have enough bandwidth to stream the audio-only variant 106 at 64 kbps while leaving an additional 86 kbps of headroom 402.

The headroom 402 available to a client device 100 beyond what it uses to stream the audio-only variant 106 can be used to stream and/or download contextual information 404. Contextual information 404 can be text, additional audio, and/or still images that show or describe the content of the video. As the audio-only variant 106 can be the video's main audio components without the corresponding visual component, in many situations the audio components alone can be insufficient to impart to a listener what is happening during the video. The contextual information 404 can show and/or describe actions, settings, and/or other information that can provide details and context to a listener of the audio-only variant 106, such that the listener can better follow what is going on without seeing the video's visual component.

By way of a non-limiting example, when a movie shows an establishing shot of a new location for a new scene, the movie's musical soundtrack alone is often not enough to inform a listener where the new scene is set. In this example, the contextual information 404 can be a text description of the new setting, an audio description of the new setting, and/or a still image of the new setting. Similarly a television show's audio components may include dialogue between two characters, but a listener may not be able to follow what the characters are physically doing from the soundtrack alone without also seeing the characters through the show's visual component. In this example, the contextual information 404 can be a text description of what the characters are doing, an audio description of what is occurring during the scene, and/or a still image of the characters.

In some embodiments or situations, text and/or audio contextual information 404 can originate from a source such as a descriptive audio track. By way of a non-limiting example, a descriptive audio track can be an audio track recorded by a Descriptive Video Service (DVS). Descriptive audio tracks can be audio recordings of spoken word descriptions of a video's visual elements. Descriptive audio tracks are often produced for blind or visually impaired people such that they can understand what is happening in a video, and generally include audible descriptions of the video's characters and settings, audible descriptions of actions being shown on screen, and/or audible descriptions of other details or context that would help a listener understand the video's plot and/or what is occurring on screen.

In some embodiments, a descriptive audio track can be a standalone audio track provided apart from a video. In other embodiments or situations the media server 102 or another device can extract a descriptive audio track from one of the audio components of an encoded video, such as an alternate descriptive audio track that can be played in addition to the video's main audio components or as an alternative to the main audio components.

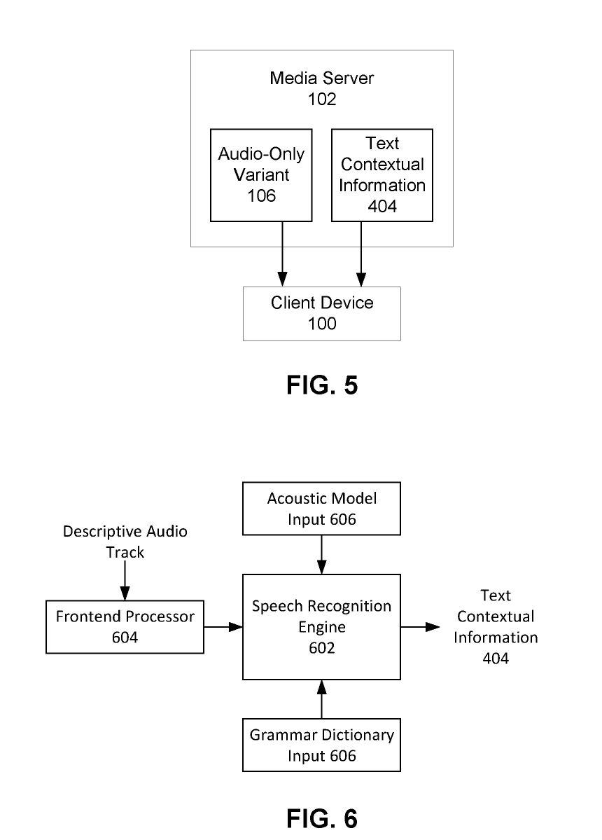

FIG. 5 depicts an embodiment or situation in which the contextual information 404 is a text description of the video's visual component. When the contextual information 404 is a text description, the client device 100 can use its available headroom 402 to download the text description and display it on the screen in addition to streaming and playing back the audio-only variant 106. In some embodiments, the text description can have time markers that correspond to time markers in the audio-only variant 106, such that a relevant portion of the text description that corresponds to the video's current visual component can be displayed at the same time as corresponding portions of the audio components are played.

In some embodiments or situations, the size of text contextual information 404 can be approximately 1-2 kB per chunk 202 of the video. As such, in the example described above in which the available headroom 402 is 86 kbps, 1-2 kB of text contextual information 404 can be downloaded with the available 86 kbps headroom 402. In alternate embodiments or situations the size of text contextual information 404 can be larger or smaller for each chunk 202.

FIG. 6 depicts an exemplary process for automatically generating text contextual information 404 from a descriptive audio track using a speech recognition engine 602. In some embodiments or situations text contextual information 404 can be a text version of a descriptive audio track, such as a DVS track, that is generated via automatic speech recognition. In these embodiments the media server 102, or any other device, can have a speech recognition engine 602 that can process a descriptive audio track and output a text contextual description 404. The text contextual description 404 output by the speech recognition engine 602 can be stored on the media server 102 so that it can be provided to client devices 100 while they are streaming an audio-only variant 106 as shown in FIG. 5. In some embodiments or situations the text contextual description 404 can be prepared by a speech recognition engine 602 substantially in real time, while in other embodiments or situations a descriptive audio track can be preprocessed by a speech recognition engine 602 to prepare the text contextual description 404 before streaming of an audio-only variant 106 is made available to client devices 100.

As shown in FIG. 6, in some embodiments a descriptive audio track can first be loaded into a frontend processor 604 for preprocessing. If the descriptive audio track was not in an expected format, in some embodiments the frontend processor 604 can convert or transcode the descriptive audio track into the expected format.

The frontend processor 604 can break the descriptive audio track into a series of individual utterances. The frontend processor 604 can analyze the acoustic activity of the descriptive audio track to find periods of silence that are longer than a predefined length. The frontend processor 604 can divide the descriptive audio track into individual utterances at such periods of silence, as they are likely to indicate the starting and ending boundaries of spoken words.

The frontend processor 604 can also perform additional preprocessing of the descriptive audio track and/or individual utterances. Additional preprocessing can include using an adaptive filter to flatten the audio's spectral slope with a time constant longer than the speech signal, and/or extracting a spectrum representation of speech waveforms, such as its Mel Frequency Cepstral Coefficients (MFCC).

The frontend processor 604 can pass the descriptive audio track, individual utterances, and/or other preprocessing data to the speech recognition engine 602. In alternate embodiments, the original descriptive audio track can be passed directly to the speech recognition engine 602 without preprocessing by a frontend processor 604.

The speech recognition engine 602 can process the individual utterances to find a best match prediction for what word it represents, based on other inputs 606 such as an acoustic model, a language model, a grammar dictionary, a word dictionary, and/or other inputs that represent a language. By way of a non-limiting example, some speech recognition engines 602 can use a word dictionary between 60,000 and 200,000 words to recognize individual words in the descriptive audio track, although other speech recognition engines 602 can use word dictionaries with fewer words or with more words. The word found to be the best match prediction for each utterance by the speech recognition engine 602 can be added to a text file that can be used as the text contextual information 404 for the video.

Many speech recognition engines 602 have been found to have accuracy rates between 70% and 90%. As descriptive audio tracks are often professionally recorded in a studio, they generally include little to no background noise that might interfere with speech recognition. By way of a non-limiting example, the descriptive audio track can be a complete associated AC-3 audio service intended to be played on its own without being combined with a main audio service, as will be described below. As such, speech recognition of a descriptive audio track is likely to be relatively accurate and serve as an acceptable source for text contextual information 404.

While in some embodiments or situations the text contextual information 404 can be generated automatically from a descriptive audio track with a speech recognition engine 602, in other embodiments or situations the text contextual information 404 can be generated through manual transcription of an descriptive audio track, through manually drafting a script, or through any other process from any other source.

In some embodiments text contextual information 404 can be downloaded by a client device 100 a separate file from the audio-only variant 106, such that its text can be displayed on screen when the audio from the audio-only variant 106 is being played. In other embodiments the text contextual information 404 can be embedded as text metadata in a file listed on a master playlist 300 as an alternate stream in addition to the video variants 104 and audio-only variants 106. By way of a non-limiting example, text contextual information 404 can be identified on a playlist with a “EXT-X-MEDIA” tag.

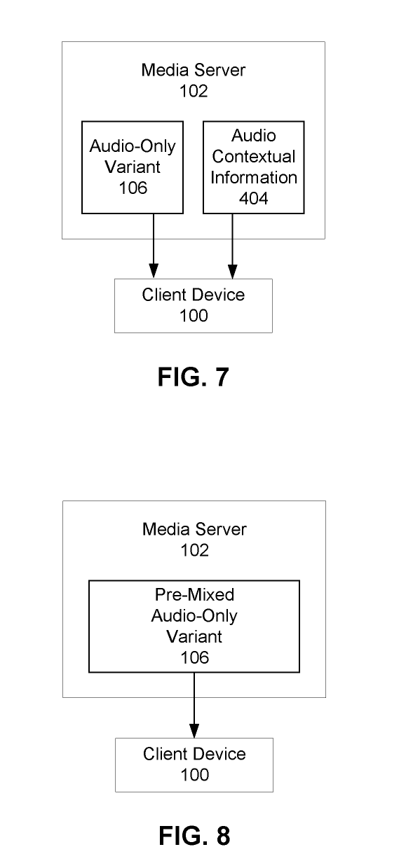

FIGS. 7 and 8 depict embodiments or situations in which the contextual information 404 is an audio recording that describes the video's visual component. In some of these embodiments or situations a descriptive audio track, such as a DVS track, can be used as audio contextual information 404.

In the embodiment of FIG. 7, audio contextual information 404 can be provided as a stream separate from the main audio-only variant 106, such that the client device 100 can use its available headroom 402 to stream the audio contextual information 404 in addition to streaming the audio-only variant 106. In these embodiments, the client device 100 can mix the audio contextual information 404 and the audio-only variant 106 together such that it can play back both audio sources and the listener can hear the video's original main audio components with an audible description of its visual component. In some embodiments, audio contextual information 404 can be marked with a “public.accessibility.describes-video” media characteristic tag or other tag, such that it can be identified by client devices 100.

FIG. 8 depicts an alternate embodiment in which a pre-mixed audio-only variant 106 can be produced and made available to client devices 100. The pre-mixed audio-only variant 106 can include the video's main audio components pre-mixed with audio contextual information 404 from a descriptive audio track or other source, such that the client device 100 can stream and play back a single audio-only variant 106 that contains both the original audio and an audio description mixed together. In some embodiments the media server 102 can make available to client devices 100 both an audio-only variant 106 without descriptive audio and a pre-mixed audio-only variant 106 that does contain descriptive audio mixed with the main audio, such that the client device 100 can choose which audio-only variant 106 to request. In other embodiments, the pre-mixed audio-only variant 106 can be the only audio-only variant 106 made available to client devices 100.

In some embodiments the client device 100 can be configured to ignore its user settings for descriptive audio when an audio-only variant 106 is being streamed, such that when an audio-only variant 106 is streamed the client device 100 either requests a single re-mixed audio-only variant 106 as in FIG. 8 or streams both the standard audio-only variant 106 and additional audio contextual information 404 as in FIG. 7. By way of a non-limiting example, in some embodiments the client device 100 can have user-changeable setting for turning descriptive audio on or off when the client device 100 is playing a video variant 104. In this example, the client device 100 can be configured to play audio contextual information 404 when an audio-only variant 106 is being played due to insufficient bandwidth to stream the lowest quality video variant 104, even if a user has set the client device 100 to not normally play descriptive audio.

While FIGS. 7 and 8 describe embodiments in which audio contextual information 404 is a prerecorded descriptive audio track, in alternate embodiments audio contextual information 404 can be generated from text contextual information 404. By way of a non-limiting example, text contextual information 404 can be prepared as described above with respect to FIG. 5, and the client device 100 can have a text-to-speech synthesizer such that the client device 100 can audibly read the text contextual information 404 as it streams and plays back the audio-only variant 106.

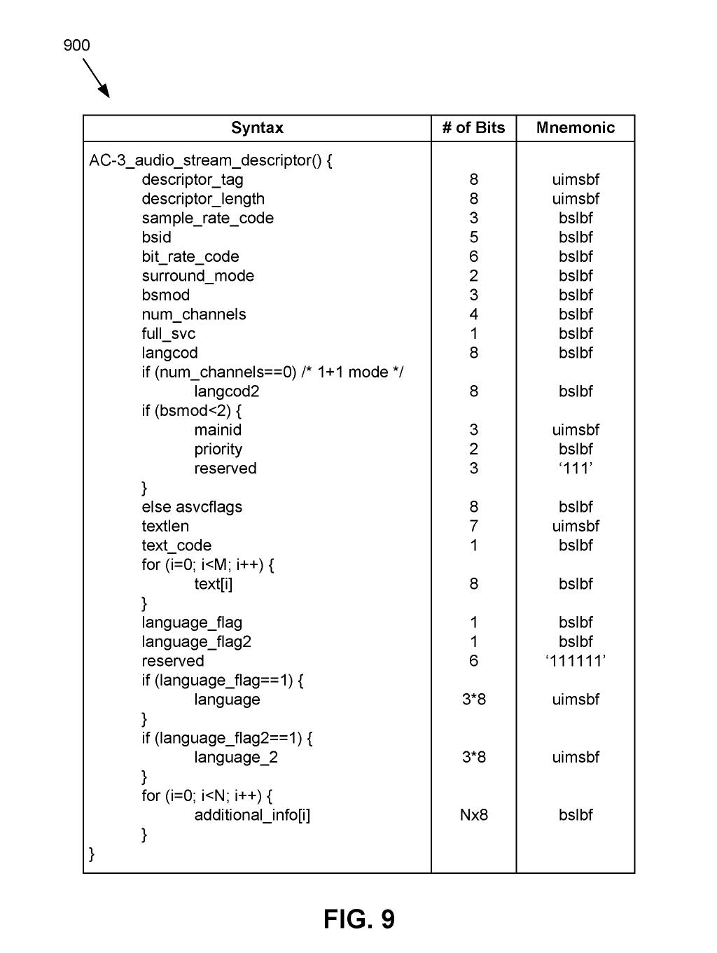

FIG. 9 depicts the syntax of an AC-3 descriptor through which a descriptive audio track in a video's audio components can be identified. As described above, in some embodiments in which a descriptive audio track is used to generate text contextual information 404 or is used as audio contextual information 404, the descriptive audio track can be extracted from a video's audio components. In some embodiments an identifier or descriptor associated with the descriptive audio track can allow a media server 102 or other device to identify and extract the descriptive audio track for use in preparing contextual information 404.

By way of a non-limiting example, in embodiments in which the audio components are encoded as AC-3 audio services, the A/53 ATSC Digital Television Standard defines different types of audio services that can be encoded for a video, including a main service, an associated service that contains additional information to be mixed with the main service, and an associated service that is a complete mix and can be played as an alternative to the main service. Each audio service can be conveyed as a single elementary stream with a unique packet identifier (PID) value. Each audio service with a unique PID can have an AC-3 descriptor in its program map table (PMT), as shown in FIG. 9.

The AC-3 descriptor for an audio services can be analyzed to find whether it indicates that the audio service is a descriptive audio track. In many situations a descriptive audio track is included as an associated service that can be combined with the main audio service, and/or as a complete associated service that contains only the descriptive audio track and that can be played back without the main audio service. By way of a non-limiting example, a descriptive audio track that is an associated service intended to be combined with a main audio track can have a “bsmod” value of ‘010’ and a “full_svc” value of 0 in its AC-3 descriptor. By way of another non-limiting example, a descriptive audio track that is a complete mix and is intended to be played back alone can have a “bsmod” value of ‘010’ and a “full_svc” value of 1 in its AC-3 descriptor. If the descriptive audio track is provided as a complete main service, it can have a “bsmod” value of ‘000’ and a “full_svc” value of 1 in its AC-3 descriptor. In some situations, multiple alternate descriptive audio tracks can be provided, and the “language” field in the AC-3 descriptor can be reviewed to find the descriptive audio track for the desired language.

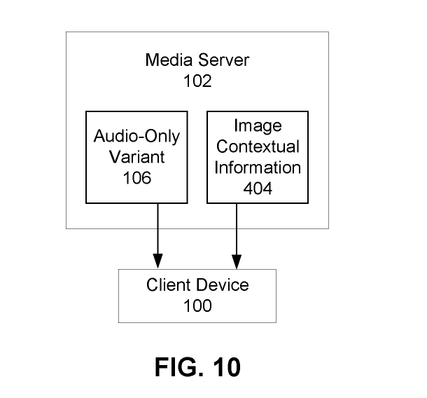

FIG. 10 depicts an embodiment or situation in which the contextual information 404 is one or more images that show a portion of the video's visual component. When the contextual information 404 is one or more images, the client device 100 can use its available headroom 402 to download the images and display them on the screen in addition to streaming and playing back the audio-only variant 106. In some embodiments image contextual information 404 can include a sequence of still images such that the image downloaded and shown to a viewer changes as the video progresses.

In some embodiments, the images presented as image contextual information 404 can be independently decodable key frames associated with each chunk 202, such as IDR frames that begin each chunk 202 of a video variant 104. As an IDR frame is the first frame of a chunk 202, it can be a representation of at least a portion of the chunk's visual components and thus provide contextual details to users who would otherwise only hear the audio-only variant 106. In alternate embodiments the image contextual information 404 can be other I-frames from a chunk, or alternately prepared still images.

Images associated with a chunk 202 of the audio-only variant 106 can be displayed at any or all points during playback of the chunk 202. By way of a non-limiting example, when the duration of each chunk 202 is five seconds, a client device can use two seconds to perform an HTTP GET request to request an image and then decode the image, leaving three seconds of the chunk 202 to display the image. In some situations the client device 100 can display an image into the next chunk's duration until the next image can be requested and displayed.

By way of a non-limiting example, in some embodiments the frames that can be used as image contextual information 404 can be frames from a video variant 104 that have a relatively low Common Intermediate Format (CIF) resolution of 352×288 pixels. An I-frame encoded with AVC at the CIF resolution is often 10-15 kB in size, although it can be larger or smaller. In this example, if the duration of each chunk 202 is five seconds and a client device 100 has 86 kpbs (10.75 kB per second) of headroom 402 available, the client device 100 can download a 15 kB image in under two seconds using the headroom 402. As the download time is less than the duration of the chunk 202, the image can be displayed partway through the chunk 202.

By way of another non-limiting example, in the same situation presented above in which the client device 100 has a headroom 402 of 86 kpbs (10.75 kB per second), the client device 100 has headroom 402 of 52.5 kB over a five second duration. As such, in some situations the client device 100 can download frames from video variants 104 that are not necessarily the lowest quality or lowest resolution video variant 104, such as downloading a frame with a 720×480 resolution if that frame's size is less than 52.5 kB.

In situations in which the image size is larger than the amount of data that can be downloaded during the duration of a chunk 202, images for future chunks 202 can be pre-downloaded and cached in a buffer for later display when the associated chunk 202 is played. Alternately, one or more images can be skipped. By way of a non-limiting example, if the headroom 402 is insufficient to download the images associated with every chunk 202, the client device 100 can instead download and display images associated with every other chunk 202, or any other pattern of chunks 202.

In some embodiments, a client device 100 can receive image contextual information 404 in addition to an audio-only variant 106 by requesting a relatively small portion of each chunk of a video variant 104 and attempting to extract a key frame, such as the beginning IDR frame, from the received portion of the chunk 202. If the client device 100 is streaming the audio-only variant 106, it likely does not have enough headroom 402 to receive an entire chunk 202 of a video variant 104, however it may have enough headroom 402 to download at least some bytes from the beginning of each chunk 202. By way of a non-limiting example, a client device 100 can use an HTTP GET command to request as many bytes from a chunk 202 as it can receive with its available headroom 402. The client device 100 can then filter the received bytes for a start code of “0x000001/0x00000001” and a Network Abstraction Layer (NAL) unit type of 5 to find the chunk's key frame. It can then extract and display the identified key frame as image contextual information 404 in addition to playing audio from the audio-only variant 106.

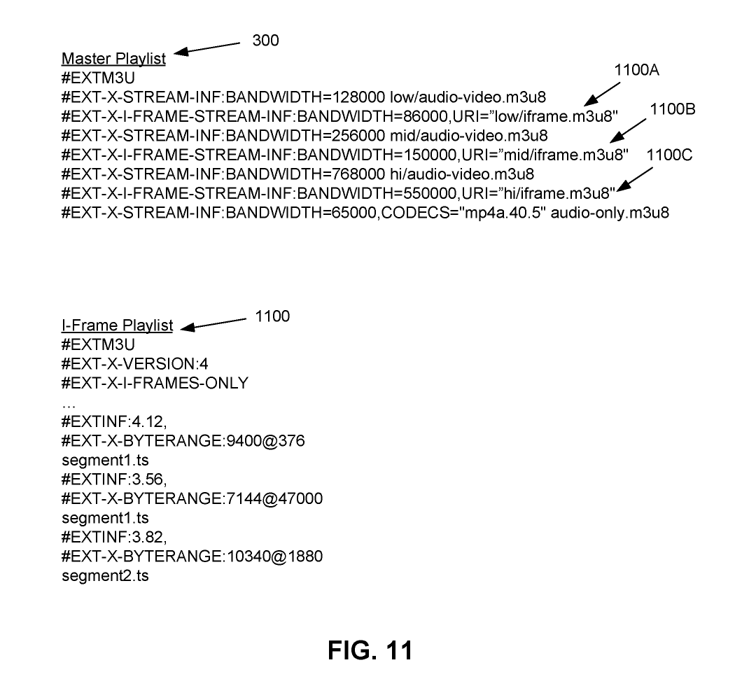

In alternate embodiments a dedicated playlist of I-frames can be prepared at the media server 102 such that a client device 100 can request and receive I-frames as image contextual information 404 as it is also streaming the audio-only variant 106. By way of a non-limiting example, FIG. 11 depicts a master playlist 200 that indicates a location for an I-frame playlist 1100 for each video variant 104. As such, the client device 100 can use the individual I-frame playlists 1100 to request high resolution still images for each chunk 202 from a high bitrate video variant 104 if it has enough headroom 402 to do so, or request lower resolution still images for each chunk 202 from lower bitrate video variants 104 if its headroom 402 is more limited. In some embodiments each I-frame playlist 1100 listed in the master playlist 200 can be identified with a tag, such as “EXT-X-I-FRAME-STREAM-INF.”

In some embodiments I-frames listed on I-frame playlists 1100 can be extracted by the media server 102 and stored as still images that can be downloaded by client devices 100 using an I-frame playlist 1100. In other embodiments the I-frame playlists 1100 can include tags, such as “EXT-X-BYTERANGE,” that identifies sub-ranges of bytes that correspond to I-frames within particular chunks 202 of a video variant 104. As such, a client device 100 can request the specified bytes to retrieve the identified I-frame instead of requesting the entire chunk 202.

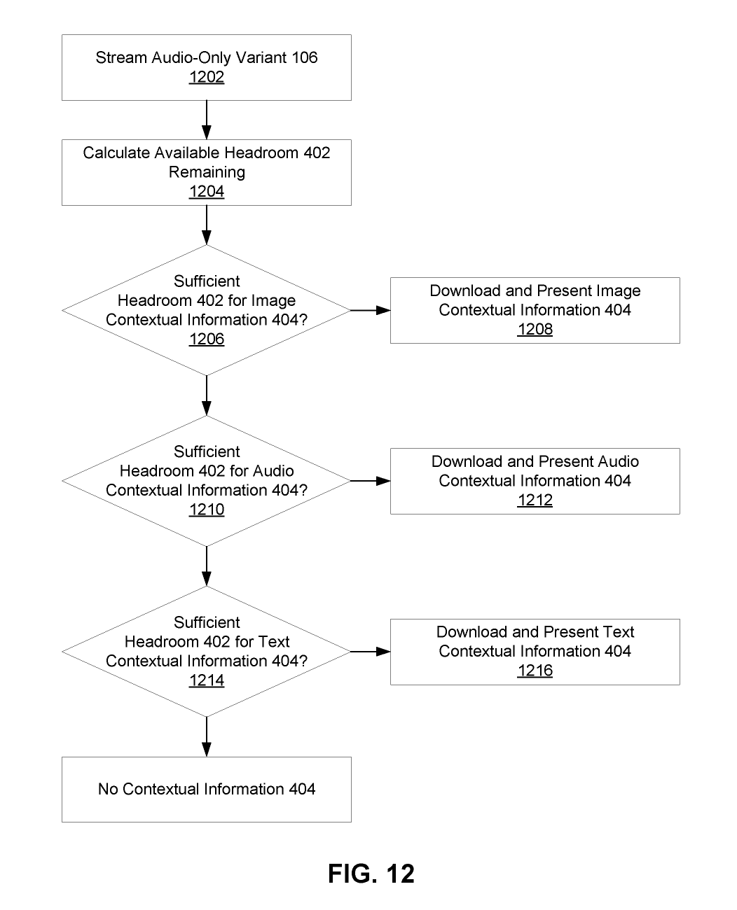

FIG. 12 depicts an exemplary embodiment of a method of selecting a type of contextual information 404 depending on the headroom 402 currently available to a client device 100. In this embodiment, the media server 102 can store contextual information 404 in multiple alternate forms, including as a text description, as an audio recording, and/or as images as described above.

At step 1202, a client device 100 can begin streaming the audio-only variant 106 of a video from a media server if it does not have enough bandwidth for the lowest-bitrate video variant 104 of that video.

At step 1204, a client device 100 can determine its current headroom 402. By way of a non-limiting example, the client device 100 can subtract the bitrate of the audio-only stream 106 from its currently available bandwidth to calculate its current headroom 402.

At step 1206, the client device 100 can determine if its headroom 402 is sufficient to retrieve image contextual information 404 from the media server 102, such that it can display still images on screen in addition to playing back the video's audio components via the audio-only variant 106. If client device 100 does have enough headroom 402 to download image contextual information 404, it can do so at step 1208. Otherwise the client device 100 can continue to step 1210.

At step 1210, the client device 100 can determine if its headroom 402 is sufficient to retrieve audio contextual information 404 from the media server 102, such that it can play back the recorded audio description of the video's visual components in addition to playing back the video's audio components via the audio-only variant 106. If client device 100 does have enough headroom 402 to download audio contextual information 404, it can do so at step 1212. Otherwise the client device 100 can continue to step 1214.

At step 1214, the client device 100 can determine if its headroom 402 is sufficient to retrieve text contextual information 404 from the media server 102, such that it can display the text contextual information 404 on screen addition to playing back the video's audio components via the audio-only variant 106. If client device 100 does have enough headroom 402 to download text contextual information 404, it can do so at step 1216. Otherwise the client device 100 can play back the audio-only variant 106 without contextual information 404, or instead stream a pre-mixed audio-only variant 106 that includes an audio description and the video's original audio components in the same stream.

In some embodiments, the client device 100 can present more than one type of contextual information 404 if there is enough available headroom 402 to download more than one type. By way of a non-limiting example, the client device 100 can be set to prioritize image contextual information 404, but use any headroom 402 remaining after the bandwidth used for both the image contextual information 404 and the audio-only variant 106 to also download and present audio contextual information 404 or image contextual information 404 if sufficient headroom 402 exists.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

1. A method of presenting contextual information during adaptive bitrate streaming, comprising:
receiving, with a client device, an audio-only variant of a video stream from a media server, wherein said audio-only variant comprises audio components of said video stream;
calculating bandwidth headroom by subtracting a bitrate associated with said audio-only variant from an amount of bandwidth currently available to said client device;
receiving, with said client device, one or more pieces of contextual information from said media server, wherein said one or more pieces of contextual information provide descriptive information about visual components of said video stream, and wherein the bitrate of said one or more pieces of contextual information is less than the calculated bandwidth headroom;
playing said audio components for users with said client device based on said audio-only variant; and
presenting said one or more pieces of contextual information to users with said client device while playing said audio components based on said audio-only variant.

2. The method of claim 1, wherein one of said one or more pieces of contextual information is a text description of said visual components of said video stream.

3. The method of claim 2, wherein said text description is a transcript of a descriptive audio track.

4. The method of claim 3, wherein said transcript is generated from said descriptive audio track using an automatic speech recognition engine.

5. The method of claim 1, wherein one of said one or more pieces of contextual information is a descriptive audio track, and presenting said one or more pieces of contextual information comprises mixing said descriptive audio track with said audio-only variant at said client device during playback.

6. The method of claim 1, wherein one of said one or more pieces of contextual information is one or more still images from said visual components of said video stream.

7. The method of claim 6, wherein said still images are independently decodable key frames extracted from each of a plurality of chunks within a video variant available at said media server, wherein said video variant comprises said audio components and said visual components of said video stream.

8. The method of claim 7, further comprising:
downloading to said client device a plurality of bytes from a beginning portion of one of said plurality of chunks;
filtering said plurality of bytes at said client device for a start code and/or unit type that identifies a key frame associated with the chunk; and
extracting a subset of bytes associated with the key frame from the plurality of bytes.

9. The method of claim 7, further comprising:
receiving a playlist of still images at said client device from said media server; and
requesting particular bytes of one of said plurality of chunks that are listed on said playlist to receive a key frame associated with the chunk.

10. The method of claim 1, wherein said video stream is delivered via an adaptive bitrate streaming technique selected from the group consisting of HTTP Live Streaming, HTTP Dynamic Streaming, Smooth Streaming, and MPEG-DASH streaming.

11. A method of presenting contextual information during adaptive bitrate streaming, comprising:
receiving, with a client device, one of a plurality of variants of a video stream from a media server, wherein said plurality of variants comprises a plurality of video variants that comprise audio components and visual components of a video, and an audio-only variant that comprises said audio components, wherein each of said plurality of video variants is encoded at a different bitrate and said audio-only variant is encoded at a bitrate lower than the bitrate of the lowest quality video variant;
selecting to receive said audio-only variant with said client device when bandwidth available to said client device is lower than the bitrate of the lowest quality video variant;
calculating bandwidth headroom by subtracting the bitrate of said audio-only variant from the bandwidth available to said client device;
downloading one or more types of contextual information to said client device from said media server with said bandwidth headroom, said one or more types of contextual information providing descriptive information about said visual components; and
playing said audio components for users with said client device based on said audio-only variant and presenting said one or more types of contextual information to users with said client device while playing said audio components based on said audio-only variant, until the bandwidth available to said client device increases above the bitrate of the lowest quality video variant and the client device selects to receive said lowest quality video variant.

12. The method of claim 11, wherein said one or more types of contextual information are selected from the group consisting of a text description of said visual components, a descriptive audio track, and one or more still images from said visual components.

13. The method of claim 12, wherein said text description is a transcript of said descriptive audio track.

14. The method of claim 13, wherein said transcript is generated from said descriptive audio track using an automatic speech recognition engine.

15. The method of claim 12, wherein said still images are independently decodable key frames extracted from each of a plurality of chunks within one of said plurality of video variants.

16. A method of presenting contextual information during adaptive bitrate streaming, comprising:
receiving, with a client device, one of a plurality of variants of a video stream from a media server, wherein said plurality of variants comprises a plurality of video variants that comprise audio components and visual components of a video, and a pre-mixed descriptive audio variant that comprises said audio components mixed with a descriptive audio track that provides descriptive information about said visual components, wherein each of said plurality of video variants is encoded at a different bitrate and said pre-mixed descriptive audio variant is encoded at a bitrate lower than the bitrate of the lowest quality video variant;
selecting to receive said pre-mixed descriptive audio variant with said client device when bandwidth available to said client device is lower than the bitrate of the lowest quality video variant; and
playing said pre-mixed descriptive audio variant for users with said client device, until the bandwidth available to said client device increases above the bitrate of the lowest quality video variant and the client device selects to receive said lowest quality video variant.

17. The method of claim 16, wherein:
said plurality of variants further comprises an audio-only variant that comprises said audio components,
said client device calculates bandwidth headroom by subtracting the bitrate of said audio-only variant from the bandwidth available to said client device, and
when said bandwidth headroom is sufficient to download said audio-only variant plus a piece of contextual information that provides descriptive information about said visual components, said client device selects to receive said audio-only variant and said piece of contextual information until the bandwidth available to said client device increases above the bitrate of the lowest quality video variant and the client device selects to receive said lowest quality video variant.

18. The method of claim 17, wherein said piece of contextual information is a text description of said visual components derived from said descriptive audio track.

19. The method of claim 18, wherein said text description is generated from said descriptive audio track using an automatic speech recognition engine.

20. The method of claim 17, wherein said piece of contextual information is a series of still images, the series of still images being independently decodable key frames extracted from each of a plurality of chunks within one of said plurality of video variants.
